(19) United States
(12) Patent Application Publication
(10) Pub. No.: US 2011/0185323 A1
(43) Pub. Date: Jul. 28, 2011

(54) Stacked Integracted Circuit Verification

(76) Inventors: WILLIAM MATTHEW HOGAN, LAKE OSWEGO, OR (US); DUSAN PETRANOVIC, CUPERTINO, CA (US); ARA ASLYAN, MOUNTAIN VIEW, CA (US)

(21) Appl. No.: 12/861,824

(22) Filed: Aug. 23, 2010

Related U.S. Application Data
(60) Provisional application No. 61/235,871, filed on Aug. 21, 2009.

(51) Int. Cl. G06F 17/50

(52) U.S. Cl. 716/52

(57) ABSTRACT

Techniques for performing physical verification processes for stacked integrated circuit devices. An interface between a first two-dimensional integrated circuit device and a second two-dimensional integrated circuit device is identified. The design data for the identified layers in the first and second two-dimensional integrated circuit devices are then combined and physically verified as a single set of interface design data. The design data for the first two-dimensional integrated circuit device and the second two-dimensional integrated circuit device are then separately physically verified. Once the interface design data, the first two-dimensional integrated circuit device design data and the second two-dimensional integrated circuit device design data have been physically verified, the verified design can be recombined to form verified design data corresponding to a stacked integrated circuit device.

### RELATED APPLICATIONS

This application claims priority to U.S. Provisional Patent Application No. 61/235,871 entitled “Stacked Integrated Circuit Verification,” filed on Aug. 21, 2009, and naming William M. Hogan and Dusan Petranovi as inventors, which application is incorporated entirely herein by reference.

### FIELD OF THE INVENTION

The present invention is directed to the verification of stacked integrated circuit devices. Various implementations of the invention may be useful for verifying a design for creating a single circuit device by stacking and electrically connecting multiple integrated circuit devices.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit being designed, its complexity, the design team, and the microcircuit fabricator or foundry that will manufacture the microcircuit. Typically, software and hardware “tools” will verify a design at various stages of the design flow by running software simulators and/or hardware emulators, and errors in the design are corrected.

Several steps are common to most design flows. Initially, the specification for the new microcircuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logical of the circuit is then analyzed, to confirm that the logic incorporated into the design will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This logical generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the functions desired for the circuit. This analysis is sometimes referred to as “formal verification.”

Once the relationships between circuit devices have been established, the design is again transformed, this time into a physical design that describes specific geometric elements. This type of design often is referred to as a “layout” design. The geometric elements define the shapes that will be created in various materials to actually manufacture the circuit device components (e.g., contacts, gates, etc.) making up the circuit. While the geometric elements are typically polygons, other shapes, such as circular and elliptical shapes, also may be employed. These geometric elements may be custom designed, selected from a library of previously-created designs, or some combination of both. Geometric elements also are added to form the connection lines that will interconnect these circuit devices. Layout tools (often referred to as “place and route” tools), such as Mentor Graphics' IC Station or Cadence's Virtuoso, are commonly used for both of these tasks.

With a layout design, each physical layer of the microcircuit will have a corresponding layer representation, and the geometric elements described in a layer representation will define the relative locations of the circuit device components that will make up a circuit device. Thus, the geometric elements in the representation of an implant layer will define the regions where doping will occur, while the geometric elements in the representation of a metal layer will define the locations in a metal layer where conductive wires used will be formed to connect the circuit devices. Typically, a designer will perform a number of analyses on the layout design. For example, the layout design may be analyzed to confirm that it accurately represents the circuit devices and their relationships described in the device design. The layout design also may be analyzed to confirm that it complies with various design requirements, such as minimum spacings between geometric elements. Still further, it may be modified to include the use of redundant or other compensatory geometric elements intended to counteract limitations in the manufacturing process, etc, so as to verify that the design can be manufactured with a high degree of reliability. These types of analysis processes are sometimes referred to as “physical verification” or “layout verification.”

After the layout design has been finalized, then it is converted into a format that can be employed by a mask or reticle writing tool to create a mask or reticle for use in a photolithographic manufacturing process. Masks and reticles are typically made using tools that expose a blank reticle to an electron or laser beam. Most mask writing tools are able to only “write” certain kinds of polygons, however, such as right triangles, rectangles or other trapezoids. Moreover, the sizes of the polygons are limited physically by the maximum beam aperture size available to the tool. Accordingly, larger geometric elements in the layout design, or geometric elements that are not basic right triangles, rectangles or trapezoids (which typically is a majority of the geometric elements in a layout design) must be “fractured” into the smaller, more basic polygons that can be written by the mask or reticle writing tool.

Once the layout design has been fractured, then the layout design data can be converted to a format compatible with the mask or reticle writing tool. Examples of such formats are MEBES, for raster scanning machines manufactured by ETEC, an Applied Materials Company, the “.MIC” format from Micronics AB in Sweden, and various vector scan formats for Nuflare, JEOL, and Hitachi machines, such as VSB12 or VSB12. The written masks or reticles can then be used in a photolithographic process to expose selected areas of a wafer in order to produce the desired integrated circuit devices on the wafer.

In the continuing effort to improve the functionality and reduce the size of integrated circuit devices, designers have traditionally employed smaller transistors and larger dies. As is has become more and more difficult to reduce transistor size further, however, some designers have begun stacking integrated circuit elements on top of one another in a third dimension to increase the functionality of integrated circuit devices without increasing the size of their footprints. Because truly homogeneous three-dimensional chip integration is still in research stages, however, the most common technique used today to create three-dimensional circuit devices is to first fabricate conventional two-dimensional circuit devices. The two-dimensional circuit devices then are integrated to form a three-dimensional device. Stacked devices using wire bond connections and flip-chips have even been employed to create system in package (SiP) solutions. Once the domain of specialist applications, more mainstream uses, such as memories, microprocessors and specialized logic designs are now being considered as candidates for stacked device technology.

A two-dimensional integrated circuit device that will be used in a stacked integrated circuit device is formed by manufacturing circuit elements and “regular” metal layers on one side of a substrate (referred to herein as the “front” side), such as a silicon substrate. If the two-dimensional integrated circuit device will be stacked on top of another two-dimensional integrated circuit device, then it also will include a limited number of patterned metal layers (typically 0 to 2) manufactured on the opposite side of the substrate (referred to herein as the “back” side). The metal layers on the back side of the substrate are electrically connected to the circuit elements and metal layers on the front side of the substrate by vias that pass through the substrate (conventionally referred to as “through-silicon vias” or TSVs). These circuit structures, which may made from copper, or tungsten, enable high frequency communication between the front side and the back side of a two-dimensional circuit device.

To form a three-dimensional integrated circuit device, the circuit elements and/or metal layers on the front side of one two-dimensional integrated circuit device are then electrically connected to the metal layers on the back side of another two-dimensional integrated circuit device. A variety of techniques may be used to electrically connect the circuit elements and/or metal layers on the front side of the first two-dimensional integrated circuit device to the metal layers on the back side of the second two-dimensional integrated circuit device, including, for example, direct oxide bonding and metal to metal (Cu—Cu) bonding, with different variants and adhesives. Currently, the most prevalent technique to stack through-silicon via based integrated circuit devices is micro-ball based “bonding”. Currently, there are three basic techniques for manufacturing a stacked integrated circuit device: wafer to wafers stacking, die to wafer stacking, and die to die stacking

Many of the capabilities required for successful physical verification of through-silicon via based integrated circuit devices exist today in some electronic design automation (EDA) tools that are commercially available, such as the Calibre® family of physical verification tools available from Mentor Graphics Corporation of Wilsonville, Oreg. One technique for verifying a stacked integrated circuit device is to combine all of designs for the component two-dimensional integrated circuit devices together for a “mega merge” multi-chip verification. Doing so, however, over complicates the verification process of TSV designs. It also creates additional disruption to existing verification flows. While conceptually simple, the “mega merge” verification requires that a number of obstacles be overcome, some of which may alter the integrity of the initial design and “golden” verification rule file. When merging all two-dimensional integrated circuit device designs into a single three-dimensional device design, a “shifting” of all the design layers must be done to incorporate all designs together without collision. Similarly, the same “shifting” must also be done in the “golden” verification rule decks, not to only avoid layer collisions, but also avoid rule check name collisions. For example, it would be quite common to have a design-rule-check DRC process rule for “wide metal”, but each technology node in the stack of two-dimensional integrated circuit devices might have a different “wide metal” rule. Accordingly, not only would the layers be shifted, but the actual rule check names would also need to be modified. Confirmation that these modifications to foundry “golden” rule decks have been carried out correctly can be a daunting task in itself

Additional obstacles might include managing design changes (ECOs) in the stacked and non-stacked versions of the design, easily altering the stack configuration while maintaining the integrity of the design files without having to re-verify each two-dimensional integrated circuit device design again, re-using a two-dimensional integrated circuit device design multiple times in the stack without un-necessary duplication, and changing the offset and rotational alignment of each two-dimensional integrated circuit device design.

### BRIEF SUMMARY OF THE INVENTION

Aspects of the invention relate to techniques of more performing physical verification processes for stacked integrated circuit devices. According to various implementations of the invention, for a stacked integrated circuit device, an interface between a first two-dimensional integrated circuit device and a second two-dimensional integrated circuit device is identified. More particularly, one or more layers on a first two-dimensional integrated circuit device are identified. The one or more layers on the second two-dimensional integrated circuit device that will be electrically connected with the one or more layers on the first two-dimensional integrated circuit device are identified as well. The design data for the identified layers in the first and second two-dimensional integrated circuit devices are then combined and physically verified as a single set of interface design data. The design data for the first two-dimensional integrated circuit device and the second two-dimensional integrated circuit device are then separately physically verified. Once the interface design data, the first two-dimensional integrated circuit device design data and the second two-dimensional integrated circuit device design data have been physically verified, the verified design can be recombined to form verified design data corresponding to a stacked integrated circuit device.

With some stacked integrated circuit device design, an interposer structure may be placed between the first two-dimensional integrated circuit device and the second two-dimensional integrated circuit device. As known in the art, these interposer structures include electrical interconnect lines that route electrical signals from contacts on the first two-dimensional integrated circuit device to corresponding contacts on the second two-dimensional integrated circuit device. With some implementations of the invention, the interface design data will include data representing the interposer. As will be discussed in more detail below, these implementations may additionally perform a routing analysis process to verify that the interposer will properly route electrical signals between corresponding contacts.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 schematically illustrates an example of a family of software tools for automatic design automation that may employ associative properties according to various embodiments of the invention.

FIG. 4 illustrates a stacked integrated circuit device verification tool that may be implemented according to various embodiments of the invention.

FIG. 5 illustrates a flowchart showing a method of verifying interface design data for a stacked integrated circuit device according to various embodiments of the invention.

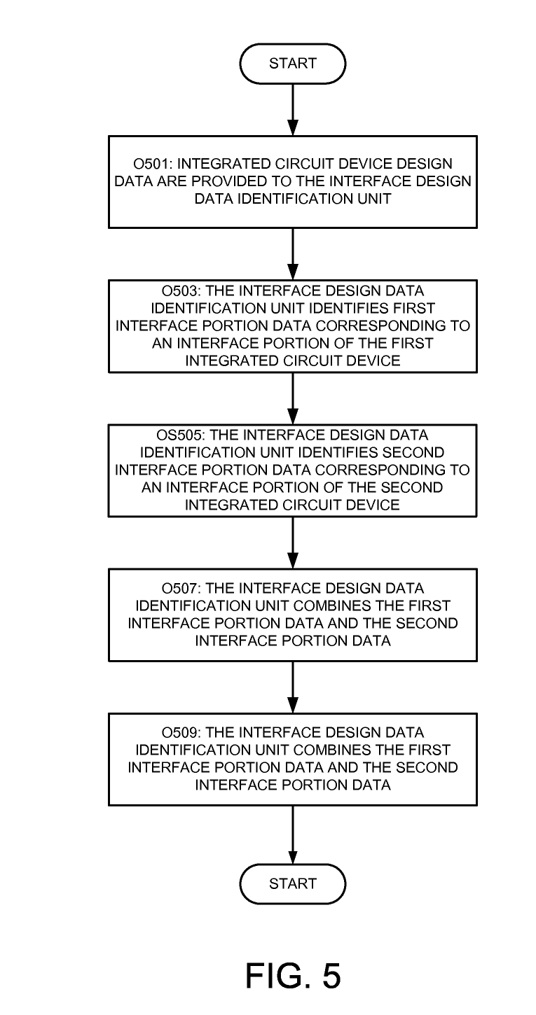

### DETAILED DESCRIPTION OF THE INVENTION

### Exemplary Operating Environment

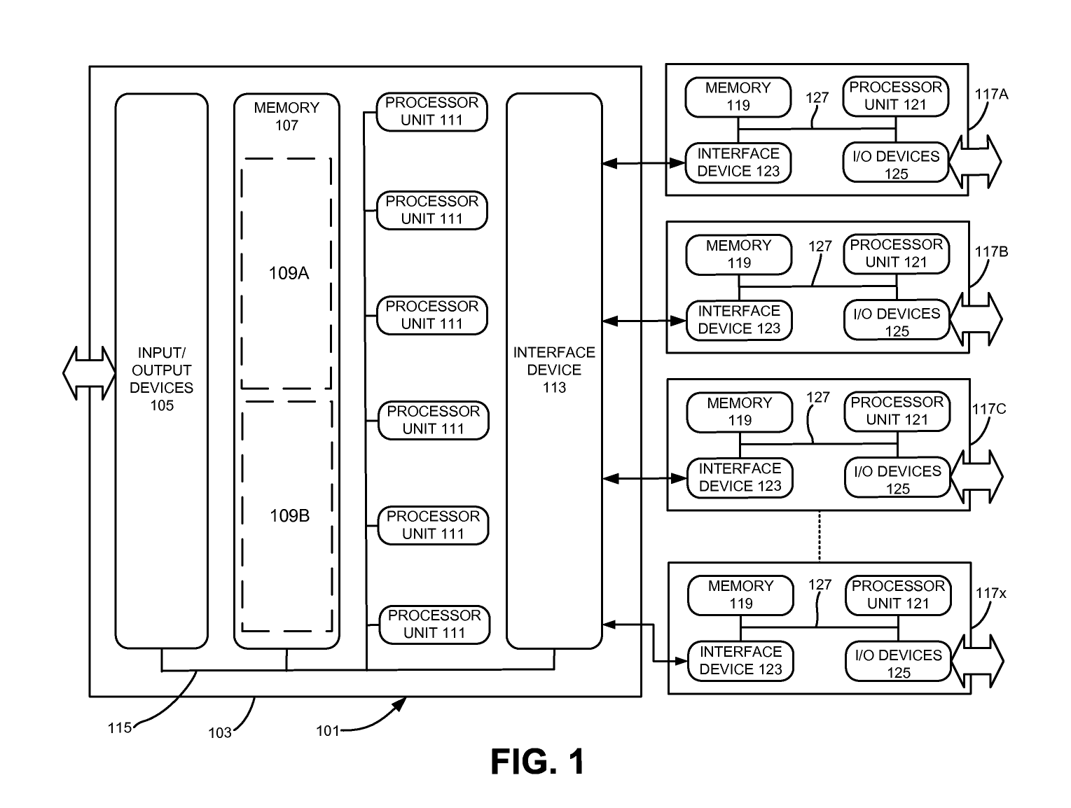

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

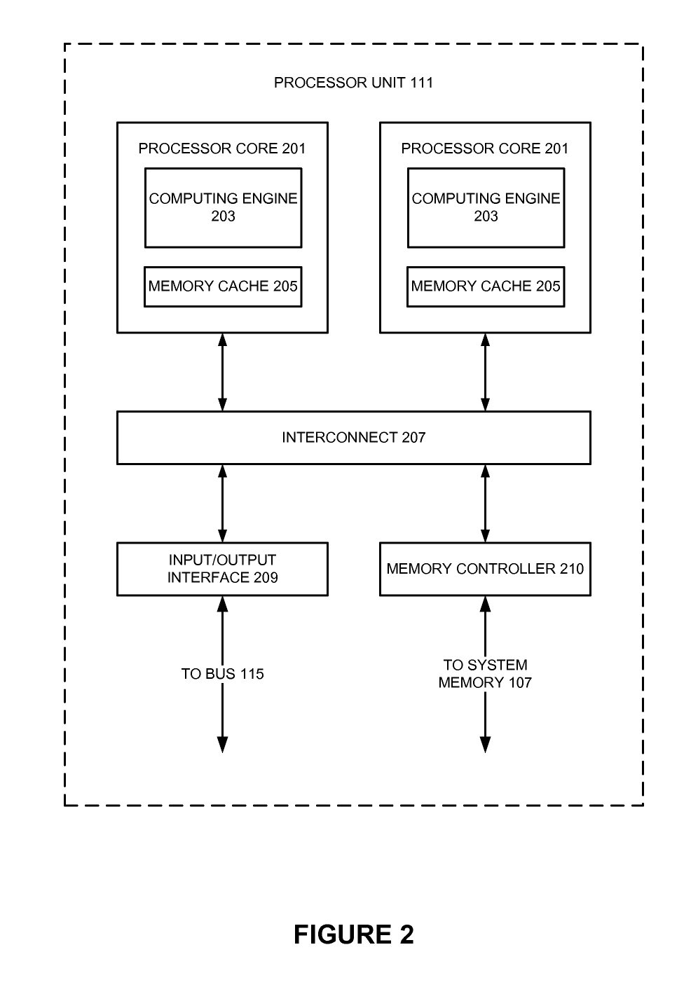

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, California, the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Electronic Design Automation Verification

As previously noted, various embodiments of the invention are related to electronic design automation. In particular, various implementations of the invention may be used to improve the operation of electronic design automation software tools that identify, verify and/or modify design data for manufacturing a microdevice, such as a microcircuit. As used herein, the terms “design” and “design data” are intended to encompass data describing an entire microdevice, such as an integrated circuit device or micro-electromechanical system (MEMS) device. This term also is intended to encompass a smaller set of data describing one or more components of an entire microdevice, however, such as a layer of an integrated circuit device, or even a portion of a layer of an integrated circuit device. Still further, the terms “design” and “design data” also are intended to encompass data describing more than one microdevice, such as data to be used to create a mask or reticle for simultaneously forming multiple microdevices on a single wafer. It should be noted that, unless otherwise specified, the term “design” as used herein is intended to encompass any type of design, including both a physical layout design and a logical design.

Designing and fabricating microcircuit devices involve many steps during a ‘design flow’ process. These steps are highly dependent on the type of microcircuit, its complexity, the design team, and the fabricator or foundry that will manufacture the microcircuit from the design. Several steps are common to most design flows, however. First, a design specification is modeled logically, typically in a hardware design language (HDL). Once a logical design has been created, various logical analysis processes are performed on the design to verify its correctness. More particularly, software and hardware “tools” verify that the logical design will provide the desired functionality at various stages of the design flow by running software simulators and/or hardware emulators, and errors are corrected. For example, a designer may employ one or more functional logic verification processes to verify that, given a specified input, the devices in a logical design will perform in the desired manner and provide the appropriate output.

In addition to verifying that the devices in a logic design will provide the desired functionality, some designers may employ a design logic verification process to verify that the logical design meets specified design requirements. For example, a designer may create rules such as, e.g., every transistor gate in the design must have an electrical path to ground that passes through no more than three other devices, or every transistor that connects to a specified power supply also must be connected to a corresponding ground node, and not to any other ground node. A design logic verification process then will determine if a logical design complies with specified rules, and identify occurrences where it does not.

After the logical design is deemed satisfactory, it is converted into physical design data by synthesis software. This physical design data or “layout” design data may represent, for example, the geometric elements that will be written onto a mask used to fabricate the desired microcircuit device in a photolithographic process at a foundry. For conventional mask or reticle writing tools, the geometric elements typically will be polygons of various shapes. Thus, the layout design data usually includes polygon data describing the features of polygons in the design. It is very important that the physical design information accurately embody the design specification and logical design for proper operation of the device. Accordingly, after it has been created during a synthesis process, the physical design data is compared with the original logical design schematic in a process sometimes referred to as a “layout-versus-schematic” (LVS) process.

Once the correctness of the logical design has been verified, and geometric data corresponding to the logical design has been created in a layout design, the geometric data then may be analyzed. For example, because the physical design data is employed to create masks used at a foundry, the data must conform to the foundry's requirements. Each foundry specifies its own physical design parameters for compliance with their processes, equipment, and techniques. Accordingly, the design flow may include a process to confirm that the design data complies with the specified parameters. During this process, the physical layout of the circuit design is compared with design rules in a process commonly referred to as a “design rule check” (DRC) process. In addition to rules specified by the foundry, the design rule check process may also check the physical layout of the circuit design against other design rules, such as those obtained from test chips, general knowledge in the industry, previous manufacturing experience, etc.

With modern electronic design automation design flows, a designer may additionally employ one or more “design-for-manufacture” (DFM) software tools. As previously noted, design rule check processes attempt to identify, e.g., elements representing structures that will almost certainly be improperly formed during a manufacturing process. “Design-For-Manufacture” tools, however, provide processes that attempt to identify elements in a design representing structures with a significant likelihood of being improperly formed during the manufacturing process. A “design-for-manufacture” process may additionally determine what impact the improper formation of the identified elements will have on the yield of devices manufactured from the circuit design, and/or modifications that will reduce the likelihood that the identified elements will be improperly formed during the manufacturing process. For example, a “design-for-manufacture” (DFM) software tool may identify wires that are connected by only a single via, determine the yield impact for manufacturing a circuit from the design based upon the probability that each individual single via will be improperly formed during the manufacturing process, and then identify areas where redundant vias can be formed to supplement the single vias.

It should be noted that, in addition to “design-for-manufacture,” various alternate terms are used in the electronic design automation industry. Accordingly, as used herein, the term “design-for-manufacture” or “design-for-manufacturing” is intended to encompass any electronic design automation process that identifies elements in a design representing structures that may be improperly formed during the manufacturing process. Thus, “design-for-manufacture” (DFM) software tools will include, for example, “lithographic friendly design” (LFD) tools that assist designers to make trade-off decisions on how to create a circuit design that is more robust and less sensitive to lithographic process windows. They will also include “design-for-yield” (DFY) electronic design automation tools, “yield assistance” electronic design automation tools, and “chip cleaning” and “design cleaning” electronic design automation tools.

After a designer has used one or more geometry analysis processes to verify that the physical layout of the circuit design is satisfactory, the designer may then perform one or more simulation processes to simulate the operation of a manufacturing process, in order to determine how the design will actually be realized by that particular manufacturing process. A simulation analysis process may additionally modify the design to address any problems identified by the simulation (i.e., to verify that the design will be reliably manufactured during a photolithographic manufacturing process). For example, some design flows may employ one or more processes to simulate the image formed by the physical layout of the circuit design during a photolithographic process, and then modify the layout design to improve the resolution of the image that it will produce during a photolithography process.

These resolution enhancement techniques (RET) may include, for example, modifying the physical layout using optical proximity correction (OPC) or by the addition of sub-resolution assist features (SRAF). Other simulation analysis processes may include, for example, phase shift mask (PSM) simulation analysis processes, etch simulation analysis processes and planarization simulation analysis processes. Etch simulation analysis processes simulate the removal of materials during a chemical etching process, while planarization simulation processes simulate the polishing of the circuit's surface during a chemical-mechanical etching process. These simulation analysis processes may identify, for example, regions where an etch or polishing process will not leave a sufficiently planar surface. These simulation analysis processes may then modify the physical layout design to, e.g., include more geometric elements in those regions to increase their density.

It should be appreciated that various design flows may repeat one or more processes in any desired order. Thus, with some design flows, geometric analysis processes can be interleaved with simulation analysis processes and/or logical analysis processes. For example, once the physical layout of the circuit design has been modified using resolution enhancement techniques, then a design rule check process or design-for-manufacturing process may be performed on the modified layout, Further, these processes may be alternately repeated until a desired degree of resolution for the design is obtained. Similarly, a design rule check process and/or a design-for-manufacturing process may be employed after an optical proximity correction process, a phase shift mask simulation analysis process, an etch simulation analysis process or a planarization simulation analysis process. Examples of electronic design tools that employ one or more of the logical analysis processes, geometry analysis processes or simulation analysis processes discussed above are described in U.S. Pat. No. 6,230,299 to McSherry et al., issued May 8, 2001, U.S. Pat. No. 6,249,903 to McSherry et al., issued Jun. 19, 2001, U.S. Pat. No. 6,339,836 to Eisenhofer et al., issued Jan. 15, 2002, U.S. Pat. No. 6,397,372 to Bozkus et al., issued May 28, 2002, U.S. Pat. No. 6,415,421 to Anderson et al., issued Jul. 2, 2002, and U.S. Pat. No. 6,425,113 to Anderson et al., issued Jul. 23, 2002, each of which are incorporated entirely herein by reference.

### Software Tools For Simulation, Verification Or Modification Of A Circuit Layout

To facilitate an understanding of various embodiments of the invention, one such software tool for automatic design automation, directed to the analysis and modification of a design for an integrated circuit, will now be generally described. As previously noted, the terms “design” and “design data” are used herein to encompass data describing an entire microdevice, such as an integrated circuit device or micro-electromechanical system (MEMS) device. These terms also are intended, however, to encompass a smaller set of data describing one or more components of an entire microdevice, such as a layer of an integrated circuit device, or even a portion of a layer of an integrated circuit device. Still further, the terms “design” and “design data” also are intended to encompass data describing more than one microdevice, such as data to be used to create a mask or reticle for simultaneously forming multiple microdevices on a single wafer. As also previously noted, unless otherwise specified, the term “design” as used herein is intended to encompass any type of design, including both physical layout designs and logical designs.

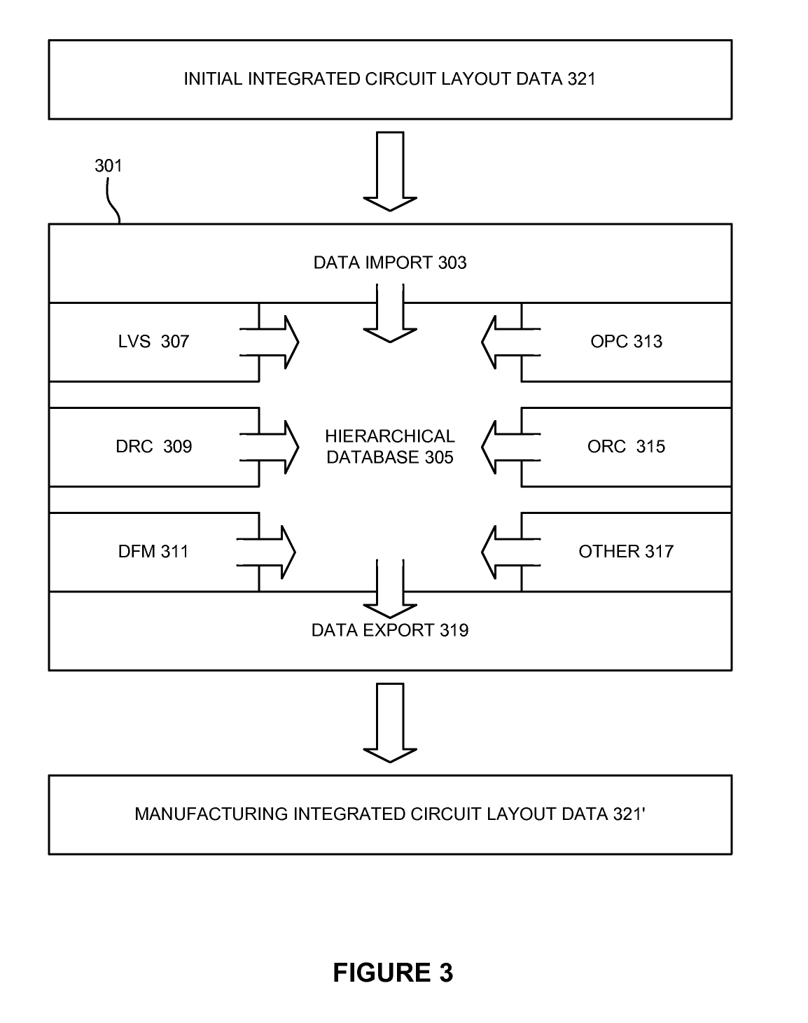

As seen in FIG. 3, an analysis tool 301, which may be implemented by a variety of different software applications, includes a data import module 303 and a hierarchical database 305. The analysis tool 301 also includes a layout-versus-schematic (LVS) verification module 307, a design rule check (DRC) module 309, a design-for-manufacturing (DFM) module 311, an optical proximity correction (OPC) module 313, and an optical proximity rule check (ORC) module 315. The analysis tool 301 may further include other modules 317 for performing additional functions as desired, such as a phase shift mask (PSM) module (not shown), an etch simulation analysis module (not shown) and/or a planarization simulation analysis module (not shown). The tool 301 also has a data export module 319. One example of such an analysis tool is the Calibre family of software applications available from Mentor Graphics Corporation of Wilsonville, Oreg.

Initially, the tool 301 receives data 321 describing a physical layout design for an integrated circuit. The layout design data 321 may be in any desired format, such as, for example, the Graphic Data System II (GDSII) data format or the Open Artwork System Interchange Standard (OASIS) data format proposed by Semiconductor Equipment and Materials International (SEMI). Other formats for the data 321 may include an open source format named Open Access, Milkyway by Synopsys, Inc., and EDDM by Mentor Graphics, Inc. The layout data 321 includes geometric elements for manufacturing one or more portions of an integrated circuit device. For example, the initial integrated circuit layout data 321 may include a first set of polygons for creating a photolithographic mask that in turn will be used to form an isolation region of a transistor, a second set of polygons for creating a photolithographic mask that in turn will be used to form a contact electrode for the transistor, and a third set of polygons for creating a photolithographic mask that in turn will be used to form an interconnection line to the contact electrode. The initial integrated circuit layout data 321 may be converted by the data import module 303 into a format that can be more efficiently processed by the remaining components of the tool 301.

Once the data import module 303 has converted the original integrated circuit layout data 321 to the appropriate format, the layout data 321 is stored in the hierarchical database 305 for use by the various operations executed by the modules 305-317. Next, the layout-versus-schematic module 307 checks the layout design data 321 in a layout-versus-schematic process, to verify that it matches the original design specifications for the desired integrated circuit. If discrepancies between the layout design data 321 and the logical design for the integrated circuit are identified, then the layout design data 321 may be revised to address one or more of these discrepancies. Thus, the layout-versus-schematic process performed by the layout-versus-schematic module 307 may lead to a new version of the layout design data with revisions. According to various implementations of the invention tool 301, the layout data 321 may be manually revised by a user, automatically revised by the layout-versus-schematic module 307, or some combination thereof.

Next, the design rule check module 309 confirms that the verified layout data 321 complies with defined geometric design rules. If portions of the layout data 321 do not adhere to or otherwise violate the design rules, then the layout data 321 may be modified to ensure that one or more of these portions complies with the design rules. The design rule check process performed by the design rule check module 309 thus also may lead to a new version of the layout design data with various revisions. Again, with various implementations of the invention tool 301, the layout data 321 may be manually modified by a user, automatically modified by the design rule check module 309, or some combination thereof

The modified layout data 321 is then processed by the design for manufacturing module 311. As previously noted, a “design-for-manufacture” processes attempts to identify elements in a design representing structures with a significant likelihood of being improperly formed during the manufacturing process. A “design-for-manufacture” process may additionally determine what impact the improper formation of the identified structures will have on the yield of devices manufactured from the circuit design, and/or modifications that will reduce the likelihood that the identified structures may be improperly formed during the manufacturing process. For example, a “design-for-manufacture” (DFM) software tool may identify wires that are connected by single vias, determine the yield impact based upon the probability that each individual single via will be improperly formed during the manufacturing process, and then identify areas where redundant visa can be formed to supplement the single vias.

The processed layout data 321 is then passed to the optical proximity correction module 313, which corrects the layout data 321 for manufacturing distortions that would otherwise occur during the lithographic patterning. For example, the optical proximity correction module 313 may correct for image distortions, optical proximity effects, photoresist kinetic effects, and etch loading distortions. The layout data 321 modified by the optical proximity correction module 313 then is provided to the optical process rule check module 315

The optical process rule check module 315 (more commonly called the optical rules check module or ORC module) ensures that the changes made by the optical proximity correction module 313 are actually manufacturable, a “downstream-looking” step for layout verification. This compliments the “upstream-looking” step of the LVS performed by the LVS module 307 and the self-consistency check of the DRC process performed by the DRC module 309, adding symmetry to the verification step. Thus, each of the processes performed by the design for manufacturing process 311, the optical proximity correction module 313, and the optical process rule check module 315 may lead to a new version of the layout design data with various revisions.

As previously noted, other modules 317 may be employed to perform alternate or additional manipulations of the layout data 321, as desired. For example, some implementations of the tool 301 may employ, for example, a phase shift mask module. As previously discussed, with a phase-shift mask (PSM) analysis (another approach to resolution enhancement technology (RET)), the geometric elements in a layout design are modified so that the pattern they create on the reticle will introduce contrast-enhancing interference fringes in the image. The tool 301 also may alternately or additionally employ, for example, an etch simulation analysis processes or a planarization simulation analysis processes. The process or processes performed by each of these additional modules 317 may also lead to the creation of a new version of the layout data 321 that includes revisions.

After all of the desired operations have been performed on the initial layout data 321, the data export module 319 converts the processed layout data 321 into manufacturing integrated circuit layout data 323 that can be used to form one or more masks or reticules to manufacture the integrated circuit (that is, the data export module 319 converts the processed layout data 321 into a format that can be used in a photolithographic manufacturing process). Masks and reticles typically are made using tools that expose a blank reticle or mask substrate to an electron or laser beam (or to an array of electron beams or laser beams), but most mask writing tools are able to only “write” certain kinds of polygons, however, such as right triangles, rectangles or other trapezoids. Moreover, the sizes of the polygons are limited physically by the maximum beam (or beam array) size available to the tool.

Accordingly, the data export module 319 may “fracture” larger geometric elements in the layout design, or geometric elements that are not right triangles, rectangles or trapezoids (which typically are a majority of the geometric elements in a layout design) into the smaller, more basic polygons that can be written by the mask or reticle writing tool. Of course, the data export module 319 may alternately or additionally convert the processed layout data 321 into any desired type of data, such as data for use in a synthesis process (e.g., for creating an entry for a circuit library), data for use in a place-and-route process, data for use in calculating parasitic effects, etc. Further, the tool 301 may store one or more versions of the layout 321 containing different modifications, so that a designer can undo undesirable modifications. For example, the hierarchical database 305 may store alternate versions of the layout data 321 created during any step of the process flow between the modules 307-317.

### Stacked Integrated Circuit Device Design Verification Tool

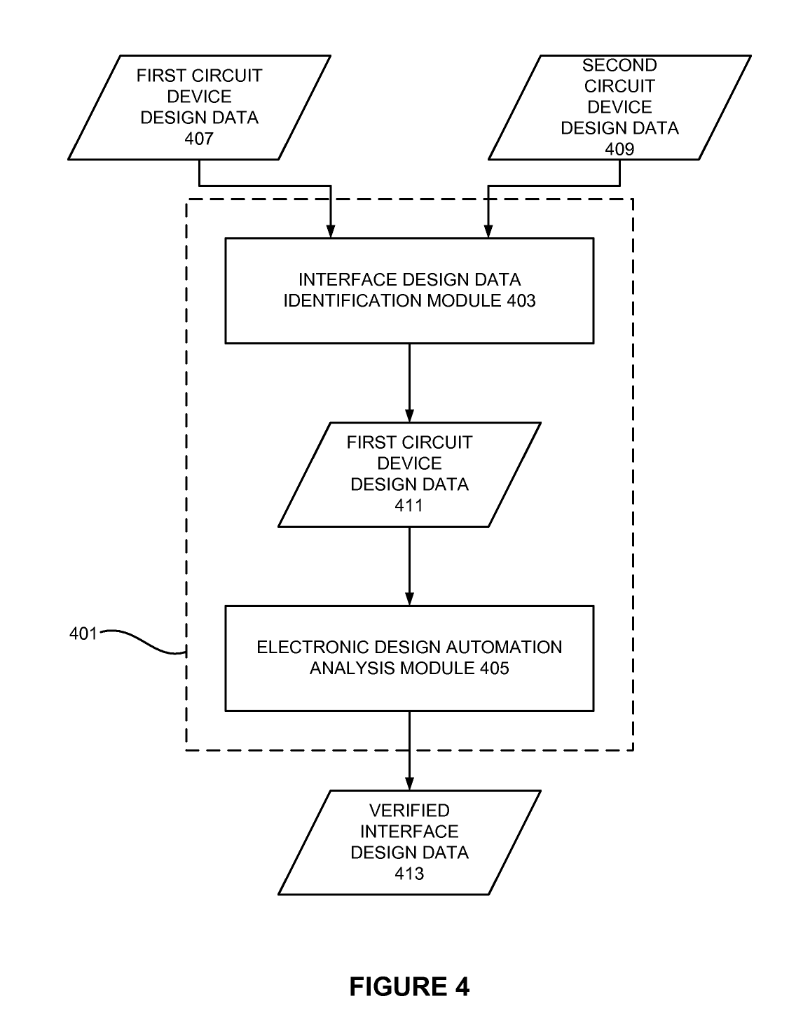

FIG. 4 illustrates a stacked integrated circuit device verification tool 401 that may be implemented according to various embodiments of the invention. As seen in this figure, the stacked integrated circuit device verification tool 401 includes an interface design data identification unit 403 and an electronic design automation analysis unit 405. With some embodiments of the invention, one or both of the interface design data identification unit 403 and the electronic design automation analysis unit 405 may be implemented by one or more programmable computers, such as the computer 101 shown in FIG. 1, executing programming instructions. Correspondingly, alternate embodiments of the invention may be implemented by software instructions for programming a programmable computer to perform the functions of one or both of the units 403 and 405 stored on a computer-readable medium. The computer-readable medium may be, for example, a magnetic storage device, an optical storage device, a “punched” surface type device, or a solid state storage device.

FIG. 4 illustrates physical verification methods that may be employed according to various embodiments of the invention. For ease of understanding, these methods will be described with reference to the stacked integrated circuit device verification tool 401 illustrated in FIG. 4. It should be appreciated, however, that alternate implementations of a stacked integrated circuit device verification tool may be used to perform the physical verification methods shown in FIG. 4. Likewise, the stacked integrated circuit device verification tool 401 may be employed to perform other physical verification analysis methods according to various embodiments of the invention.

Initially, in operation 501, design data for a first two-dimensional integrated circuit device and design data for a second two-dimensional integrated circuit device are provided to the interface design data identification unit 403. As will be appreciated by those of ordinary skill in the art, the design data will be provided for a first two-dimensional integrated circuit device and a second two-dimensional integrated circuit device that will be adjacent to each other (and directly electrically connected) in a stacked integrated circuit device. Next, in operation 503, the interface design data identification unit 403 analyzes the design data for the first two-dimensional integrated circuit device to identify first interface portion data corresponding to an interface portion of the first two-dimensional integrated circuit device. In operation 505, the interface design data identification unit 403 similarly analyzes the design data for the second two-dimensional integrated circuit device to identify second interface data corresponding to an interface portion of the second two-dimensional integrated circuit device. With various implementations of the invention, the interface portion of the first two-dimensional integrated circuit device will be the one or two circuit layers closest to the second two-dimensional integrated circuit device. Similarly, the interface portion of the second two-dimensional integrated circuit device will be the one or two circuit layers closest to the first two-dimensional integrated circuit device. It should be appreciated, however, that some implementations may employ three or more circuit layers of the first two-dimensional integrated circuit device, the second two-dimensional integrated circuit device, or both as the interface portions.

Next, in operation 507, the interface design data identification unit 403 combines the first interface portion data and the second interface portion data to produce interface design data 411, which is provided to the electronic design automation analysis unit 405. The electronic design automation analysis unit 405 may incorporate or otherwise employ one or more electronic design automation process tools, such as one or more components of the analysis tool 301 discussed in detail above. Accordingly, in operation 509, the electronic design automation analysis unit 405 performs one or more physical verification processes on the interface design data 411 to produce verified interface design data 413.

With some stacked integrated circuit device designs, an interposer structure may be located between the first two-dimensional integrated circuit device and the second two-dimensional integrated circuit device. As known in the art, an interposer structure include electrical interconnect lines that route electrical signals from contacts on the first two-dimensional integrated circuit device to corresponding contacts on the second two-dimensional integrated circuit device. With some implementations of the invention, the interface design data identification unit 403 will combine the design data for interposer structure with the first interface portion data and the second interface portion data to produce the interface design data 411. Further, these implementations may additionally perform a routing analysis process to verify that the interposer will properly route electrical signals between corresponding contacts. For example, the stacked integrated circuit device verification tool 401 may employ a layout-versus-schematic EDA tool to trace the interconnect routing.

As previously mentioned, the design data for the first and second two-dimensional integrated circuit devices may be separately physically verified using distinct physical verification processes. For example, the design data for the first two-dimensional integrated circuit device and/or second two-dimensional integrated circuit device may be verified in a verification process occurring before, after, or concurrently with the verification of the interface design data 411. Also, the design data for the first two-dimensional integrated circuit device may be verified by the electronic design automation analysis unit 405, while, e.g., the design data for the second two-dimensional integrated circuit device may be verified by a separate entity, and provided to the design in a verified form.

Once the interface design data 411, the design data for the first two-dimensional integrated circuit device, and the design data for the second have all been verified, then the verified interface design data 413 can be combined with the verified design data for the first and second two-dimensional integrated circuit devices to produce combined verified design data. This process can be repeated for each combination of two-dimensional integrated circuit devices in a stacked integrated circuit device, until verified design data for the entire stacked integrated circuit device is produced. For example, if a stacked integrated circuit device includes a larger wafer with multiple duplicate dies (e.g., for memory circuits), then the process illustrated in FIG. 4 may be repeated for each die.

With some implementations of the invention, the verification process performed by the electronic design automation analysis unit 405 may require parasitic information. With these implementations, the electronic design automation analysis unit 405 (or toher tool) may analyze design data for one or more two-dimensional integrated circuit devices in the stacked integrated circuit device together to obtain the parasitic information. For example, some implementations of the invention may combine the design data for one or more of the stacked two-dimensional integrated circuit devices, and then use a layout-versus-schematic process to generate a netlist based upon the combined data.

### Conclusion

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

1. A method of analyzing a circuit design, comprising:
identifying first interface portion design data corresponding to an interface portion of a first two-dimensional integrated circuit device;
identifying second interface portion design data corresponding to an interface portion of a second two-dimensional integrated circuit device;
combining the first interface portion design data with the second interface portion design data to generate interface design data; and
performing a physical verification process on the interface design data to produce verified interface design data.

2. The method recited in claim 1, further comprising
combining interposer design data with the first interface portion design data and the second interface portion design data to generate the interface design data.

3. The method recited in claim 2, wherein the physical verification process performed on the interface design data includes a verification process to trace interconnect routing through the interposer design data.

4. The method recited in claim 2, wherein the physical verification process performed on the interface design data includes a layout-versus-schematic verification process to trace interconnect routing through the interposer design data.

5. The method recited in claim 1, wherein the physical verification process performed on the interface design data includes a layout-versus-schematic verification process to generate a netlist for the interface design data.

6. A computer-readable medium storing thereon instructions configured to instruct a computer to execute a method comprising:
identifying first interface portion design data corresponding to an interface portion of a first two-dimensional integrated circuit device;
identifying second interface portion design data corresponding to an interface portion of a second two-dimensional integrated circuit device;
combining the first interface portion design data with the second interface portion design data to generate interface design data; and
performing a physical verification process on the interface design data to produce verified interface design data.

7. The computer-readable medium recited in claim 6, wherein the method further comprises combining interposer design data with the first interface portion design data and the second interface portion design data to generate the interface design data.

8. The computer-readable medium recited in claim 7, wherein the physical verification process performed on the interface design data includes a verification process to trace interconnect routing through the interposer design data.

9. The computer-readable medium recited in claim 7, wherein the physical verification process performed on the interface design data includes a layout-versus-schematic verification process to trace interconnect routing through the interposer design data.

10. The computer-readable medium recited in claim 6, wherein the physical verification process performed on the interface design data includes a layout-versus-schematic verification process to generate a netlist for the interface design data.

11. A stacked integrated circuit device verification tool, comprising:
an interface design data identification module configured to
identify a first interface portion design data corresponding to an interface portion of a first two-dimensional integrated circuit device,
identify a second interface portion design data corresponding to an interface portion of a second two-dimensional integrated circuit device, and
combine the first interface portion design data with the second interface portion design data to generate interface design data; and
an electronic design automation analysis module configured to perform a physical verification process on the interface design data to produce verified interface design data

12. The method recited in claim 11, wherein the interface design data identification module further is configured to combine interposer design data with the first interface portion design data and the second interface portion design data to generate the interface design data.

13. The method recited in claim 12, wherein the electronic design automation analysis module further is configured to perform a verification process on the interface design data to trace interconnect routing through the interposer design data.

14. The method recited in claim 12, wherein the electronic design automation analysis module further is configured to perform a layout-versus-schematic verification process on the interface design data to trace interconnect routing through the interposer design data.

15. The method recited in claim 11, wherein the electronic design automation analysis module further is configured to perform a layout-versus-schematic verification process on the interface design data to generate a netlist for the interface design data.
